(19) United States
(12) Patent Application Publication
(10) Pub. No.: US 2020/0005337 A1
(43) Pub. Date: Jan. 2, 2020

(54) AGGREGATION APPARATUS AND AGGREGATION METHOD

(71) Applicant: FUJITSU LIMITED, Kawasaki-shi (JP)

(72) Inventor: Yoshitaka Suehiro, Kobe (JP)

(73) Assignee: FUJITSU LIMITED, Kawasaki-shi (JP)

(21) Appl. No.: 16/451,623

(22) Filed: Jun. 25, 2019

(30) Foreign Application Priority Data
Jun. 27, 2018 (JP) 2018-121988

(51) Int. Cl. G06Q 30/02; G06F 16/2455

(52) U.S. Cl. CPC G06Q 30/0201; G06F 16/24556

(57) ABSTRACT

An aggregation apparatus includes one or more memories and one or more processors configured to identify, in response to receiving an instruction for aggregation, one or more aggregation results related to the instruction from a plurality of aggregation results of a plurality of periods stored in the one or more memories, perform determination of whether the identified one or more aggregation results include a first aggregation result aggregated by using first data at first timing before second timing of the receiving of the instruction, the first data being different from second data at the second timing, perform calculation of a second aggregation result by using the first data, and perform output for the instruction based on the calculated second aggregation result and one or more aggregation results other than the first aggregation result in the identified one or more aggregation results.

### CROSS-REFERENCE TO RELATED APPLICATION

This application is based upon and claims the benefit of priority of the prior Japanese Patent Application No. 2018-121988, filed on Jun. 27, 2018, the entire contents of which are incorporated herein by reference.

### FIELD

The embodiments discussed herein are related to an aggregation technique.

### BACKGROUND

For example, a provider that provides services to a user (hereinafter, also referred to as provider) constructs and operates an information processing system for providing the services. For example, the provider constructs an information processing system that aggregates sales data of products or the like (hereinafter, also referred to as original data) based on a unit of aggregation instructed by the user.

The information processing system aggregates, for example, original data generated on a certain day by executing batch processing in a time zone in which other processes are not executed (for example, nighttime of the day of the generation of the original data to be aggregated). This allows the information processing system to reduce the influence of the aggregation of the original data on other processes.

For example, related techniques are disclosed in Japanese Laid-open Patent Publication No. 59-117665 and Japanese Laid-open Patent Publication No. 02-178768.

### SUMMARY

According to an aspect of the embodiments, an aggregation apparatus includes one or more memories and one or more processors configured to identify, in response to receiving an instruction for aggregation, one or more aggregation results related to the instruction from a plurality of aggregation results of a plurality of periods stored in the one or more memories, perform determination of whether the identified one or more aggregation results include a first aggregation result aggregated by using first data at first timing before second timing of the receiving of the instruction, the first data being different from second data at the second timing, perform calculation of a second aggregation result by using the first data, and perform output for the instruction based on the calculated second aggregation result and one or more aggregation results other than the first aggregation result in the identified one or more aggregation results.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts a configuration of an information processing system;

FIG. 2 is a diagram describing a hardware configuration of an information processing apparatus;

FIG. 3 is a block diagram of functions of an information processing apparatus;

FIG. 4 is a flow chart describing an outline of a result output process according to a first embodiment;

FIG. 5 is a diagram describing an outline of a result output process according to the first embodiment;

FIG. 6 is a diagram describing an outline of a result output process according to the first embodiment;

FIG. 7 is a diagram describing an outline of a result output process according to the first embodiment;

FIG. 8 is a flow chart describing details of a result output process according to the first embodiment;

FIG. 9 is a flow chart describing details of a result output process according to the first embodiment;

FIG. 10 is a flow chart describing details of a result output process according to the first embodiment;

FIG. 11 is a flow chart describing details of a result output process according to the first embodiment;

FIG. 12 is a flow chart describing details of a result output process according to the first embodiment;

FIG. 13 is a diagram describing a specific example of non-aggregated data;

FIG. 14 is a diagram describing details of a result output process according to the first embodiment;

FIG. 15 is a diagram describing a specific example of aggregated data;

FIG. 16 is a diagram describing details of a result output process according to the first embodiment;

FIG. 17 is a diagram describing details of a result output process according to the first embodiment;

FIG. 18 is a diagram describing details of a result output process according to the first embodiment;

FIG. 19 is a flow chart describing a result output process according to a second embodiment;

FIG. 20 is a flow chart describing a result output process according to the second embodiment;

FIG. 21 is a diagram describing a specific example of aggregation unit information;

FIG. 22 is a diagram describing a result output process according to the second embodiment;

FIG. 23 is a diagram describing a result output process according to the second embodiment;

FIG. 24 is a diagram describing a result output process according to the second embodiment;

FIG. 25 is a diagram describing a result output process according to the second embodiment;

FIG. 26 is a diagram describing a result output process according to the second embodiment; and

FIG. 27 is a diagram describing a result output process according to the second embodiment.

### DESCRIPTION OF EMBODIMENTS

For example, original data may include correction data for original data generated in the past (hereinafter, also simply referred to as correction data). In this case, an information system may need to aggregate the original data generated in that day, and, in addition, need to reaggregate the original data generated in the past.

However, the information processing system may not be able to, for example, determine whether the original data includes the correction data before the aggregation of the original data. Therefore, the original data may need to be reaggregated for, for example, all days in which there is a possibility of generation of correction data, and the time it takes to aggregate the original data may become long.

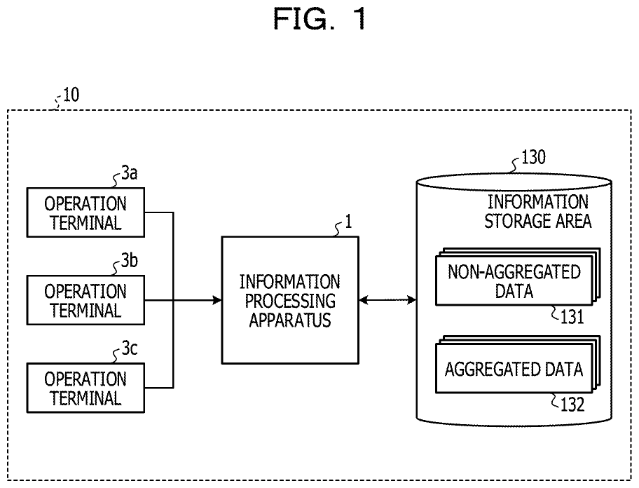

FIG. 1 depicts a configuration of an information processing system 10. For example, the information processing apparatus 10 illustrated in FIG. 1 includes an information processing apparatus 1, an information storage area 130, and operation terminals 3a, 3b, and 3c. The operation terminals 3a, 3b, and 3c will also be collectively referred to as an operation terminal 3. The information storage area 130 may be positioned in the information processing apparatus 1 or may be positioned in a storage apparatus (not illustrated) positioned outside of the information processing apparatus 1. The information processing apparatus 1 is an example of an aggregation apparatus.

The operation terminal 3 is, for example, a personal computer (PC) used by a user that receives services and is a terminal arranged in each store that performs operation such as selling products. In the operation terminal 3, for example, a person in charge in each store (hereinafter, also simply referred to as person in charge) inputs sales data and the like (hereinafter, also referred to as non-aggregated data 131) in each store. The operation terminal 3 then transmits the input non-aggregated data 131 to the information processing apparatus 1. In the following description, the non-aggregated data 131 is sales data of each store (each store that has sold products), each product (each type of product sold), and each time period (each time period that the product is sold) and is data with a possibility of including correction data for the non-aggregated data 131 of the previous day or two days ago.

The information processing apparatus 1 is, for example, one or more physical machines or virtual machines and is configured to aggregate the non-aggregated data 131 transmitted from each operation terminal 3 to create aggregated data 132. The information processing apparatus 1 outputs, for example, the created aggregated data 132 to an output terminal (not illustrated).

When the information processing apparatus 1 determines that the non-aggregated data 131 transmitted from each operation terminal 3 includes correction data, the information processing apparatus 1 reaggregates the aggregated data 132 corresponding to the correction data (aggregated data 132 created in the past).

The information processing apparatus 1 may not be able to determine whether the non-aggregated data 131 transmitted from each operation terminal 3 includes correction data before the creation of the aggregated data 132 is started. Therefore, for example, the information processing apparatus 1 needs to reaggregate the aggregated data 132 for all days in which there is a possibility of generation of correction data, and the time it takes to create the aggregated data 132 may become long.

Therefore, when the information processing apparatus 1 in the embodiments receives an instruction for aggregating the non-aggregated data 131, the information processing apparatus 1 specifies the instructed aggregated data 132 to be aggregated from the created aggregated data 132. The information processing apparatus 1 then determines whether the specified aggregated data 132 includes aggregated data 132 (hereinafter, also referred to as first aggregated data 132) created from the non-aggregated data 131 in which data at certain timing before the reception of the instruction for aggregation and data at timing of the reception of the instruction for aggregation are different.

As a result, when the information processing apparatus 1 determines that there is the first aggregated data 132, the information processing apparatus 1 reaggregates the first aggregated data 132. The information processing apparatus 1 then calculates an aggregation result corresponding to the instruction for aggregation based on the reaggregated first aggregated data 132 and the aggregated data 132 other than the first aggregated data 132 in the specified aggregated data 132 and outputs the aggregation result.

For example, the information processing apparatus 1 specifies that the aggregated data 132 created from the non-aggregated data 131 that varies between the timing of the reception of the instruction for aggregation and the timing before the timing is the aggregated data 132 that needs to be reaggregated due to the generation of the correction data. The information processing apparatus 1 reaggregates only the specified aggregated data 132.

This allows the information processing apparatus 1 to efficiently create the aggregated data 132. Therefore, the information processing apparatus 1 may be able to shorten the time for creating the aggregated data 132 and may be able to reduce the influence of the creation of the aggregated data 132 on other processes.

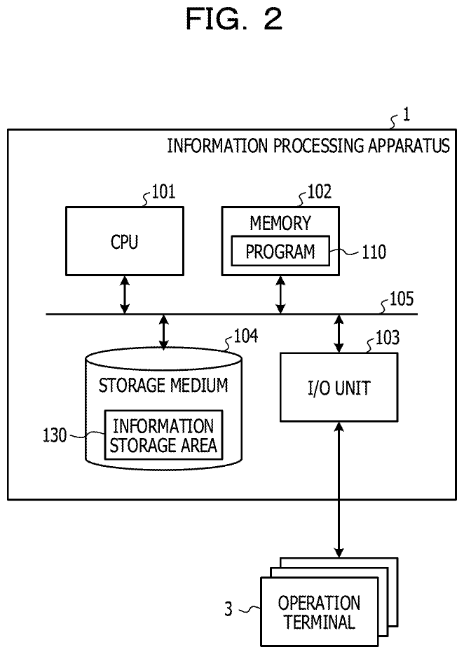

Next, a hardware configuration of the information processing system 10 will be described. FIG. 2 is a diagram describing a hardware configuration of an information processing apparatus. The information processing apparatus illustrated in FIG. 2 may be the information processing apparatus 1 illustrated in FIG. 1.

As illustrated in FIG. 2, the information processing apparatus 1 includes a central processing unit (CPU) 101 that is a processor, a memory 102, an external interface (input-output (I/O) unit) 103, and a storage medium 104. The components are coupled to each other through a bus 105.

The storage medium 104 includes, for example, a program storage area (not illustrated) for storing a program 110 for executing a process of calculating and outputting the aggregation result of the aggregated data 132 (hereinafter, referred to as result output process). The storage medium 104 also includes, for example, the information storage area 130 (hereinafter, also referred to as storage unit 130) for storing information used in the result output process. The storage medium 104 may be, for example, a hard disk device (HDD).

The CPU 101 executes the program 110 loaded on the memory 102 from the storage medium 104 to execute the result output process.

The external interface 103 communicates with, for example, the operation terminal 3.

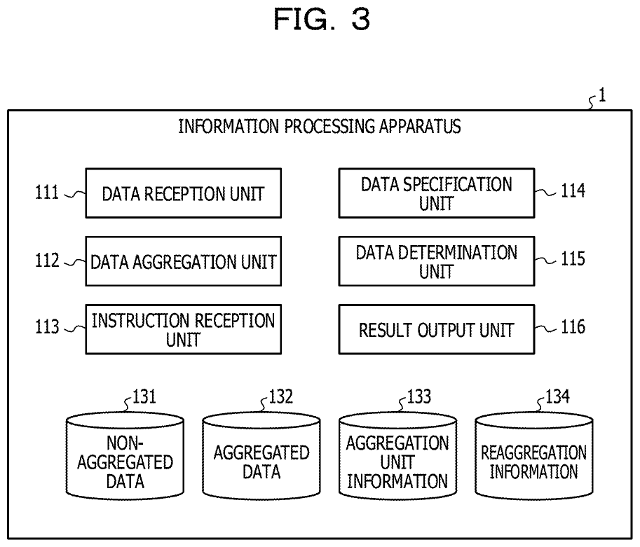

Next, functions of an information processing system will be described. FIG. 3 is a block diagram of functions of an information processing apparatus 1. The information processing apparatus illustrated in FIG. 3 may be the information processing apparatus 1 illustrated in FIG. 1.

As illustrated in FIG. 3, hardware, such as the CPU 101 and the memory 102, and the program 110 including a plurality of commands organically cooperate, and the information processing apparatus 1 realizes various functions including a data reception unit 111, a data aggregation unit 112, an instruction reception unit 113, a data specification unit 114, a data determination unit 115, and a result output unit 116.

The information processing apparatus 1 stores the non-aggregated data 131, the aggregated data 132, aggregation unit information 133, and reaggregation information 134 in the information storage area 130 as illustrated in FIG. 3.

The data reception unit 111 receives the non-aggregated data 131 transmitted from the operation terminal 3. The data reception unit 111 stores, for example, the received non-aggregated data 131 in the information storage area 130.

The data aggregation unit 112 aggregates the non-aggregated data 131 received by the data reception unit 111 to create the aggregated data 132.

For example, the data aggregation unit 112 refers to attribute information (hereinafter, also referred to as attribute identification (ID)) included in each piece of the non-aggregated data 131 and specifies the date and time of generation of each piece of the non-aggregated data 131. The data aggregation unit 112 creates the aggregated data 132 of each specific period (for example, each hour) by, for example, aggregating the non-aggregated data 131 of each specific period and stores the aggregated data 132 in the information storage area 130.

Note that the data aggregation unit 112 may, for example, refer to correspondence information (not illustrated) associating the attribute information with various types of information, such as date and time, to specify the date and time of the generation of each piece of the non-aggregated data 131.

The instruction reception unit 113 receives, for example, an instruction for further aggregating each piece of the aggregated data 132 stored in the information storage area 130 based on the unit of aggregation determined by the provider. For example, the instruction reception unit 113 receives an instruction for aggregation issued to the information processing apparatus 1 by the provider.

In response to the reception of the instruction for aggregation received by the instruction reception unit 113, the data specification unit 114 specifies, from the aggregated data 132 stored in the information storage area 130, the aggregated data 132 to be aggregated designated for the instruction reception unit 113.

The data determination unit 115 determines whether the aggregated data 132 specified by the data specification unit 114 includes the first aggregated data 132 generated from the non-aggregated data 131 in which the data at certain timing before the reception of the instruction for aggregation received by the instruction reception unit 113 and the data at timing of the reception of the instruction for aggregation received by the instruction reception unit 113 are different. When the data determination unit 115 determines that there is the first aggregated data 132, the data aggregation unit 112 reaggregates the first aggregated data 132 determined to exist.

The result output unit 116 calculates an aggregation result corresponding to the instruction for aggregation received by the instruction reception unit 113 based on the first aggregated data 132 reaggregated by the data aggregation unit 112 and the aggregated data 132 other than the first aggregated data 132 in the aggregated data 132 specified by the data specification unit 114. The result output unit 116 outputs the calculated aggregation result to a provider terminal (not illustrated). Specific examples of the aggregation unit information 133 and the reaggregation information 134 will be described later.

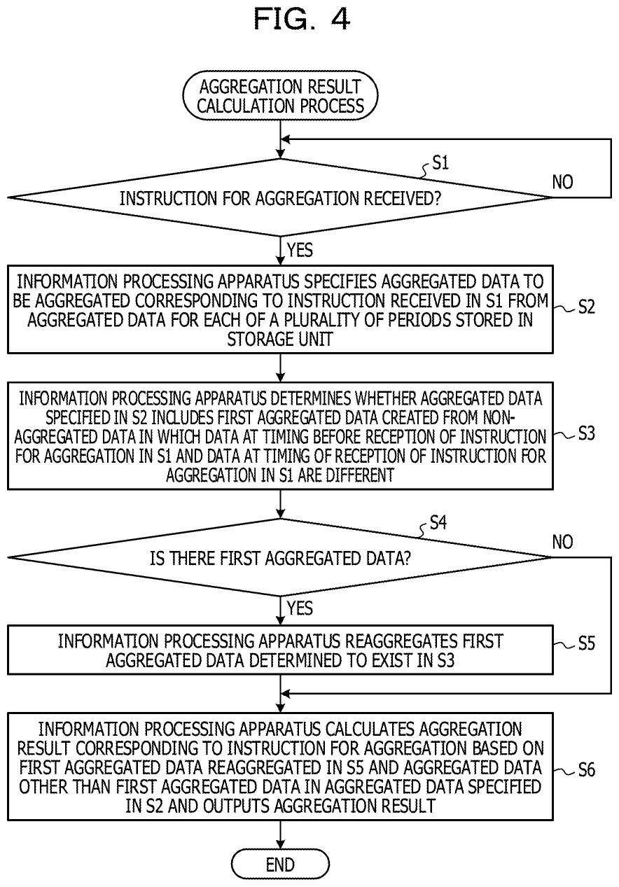

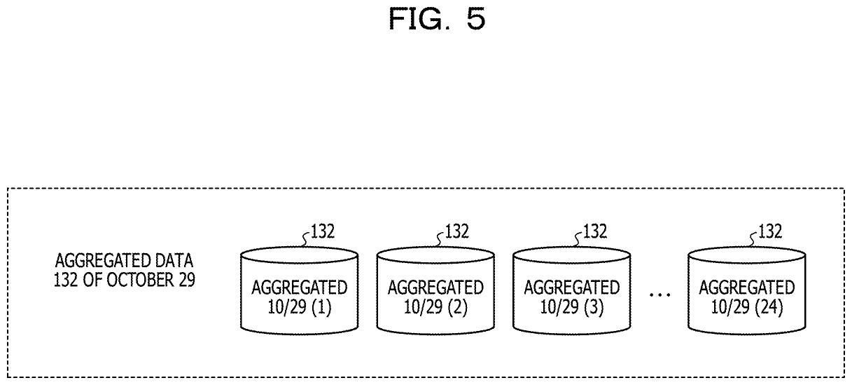

Next, an outline of a first embodiment will be described. FIG. 4 is a flow chart describing an outline of a result output process according to the first embodiment. FIGS. 5 to 7 are diagrams describing an outline of a result output process according to the first embodiment.

The instruction reception unit 113 of the information processing apparatus 1 waits for the reception of an instruction for aggregating the aggregated data 132 as illustrated in FIG. 4 (NO in S1). For example, the instruction reception unit 113 waits until the provider inputs the instruction for aggregating the aggregated data 132 to the information processing apparatus 1 through the provider terminal (not illustrated).

If the instruction for aggregating the aggregated data 132 is received (YES in S1), the data specification unit 114 of the information processing apparatus 1 specifies the aggregated data 132 to be aggregated corresponding to the instruction received in the process of S1 from the aggregated data 132 for each of a plurality of periods stored in the information storage area 130 (S2).

The data determination unit 115 of the information processing apparatus 1 then determines whether the aggregated data 132 specified in the process of S2 includes the first aggregated data 132 created from the non-aggregated data 131 in which the data at the timing before the reception of the instruction for aggregation received in the process of S1 and the data at the timing of the reception of the instruction for aggregation received in the process of S1 are different (S3).

As a result, if the data determination unit 115 determines that there is the first aggregated data 132 (YES in S4), the data aggregation unit 112 of the information processing apparatus 1 reaggregates the first aggregated data 132 determined to exist in the process of S3 (S5). For example, the data determination unit 115 instructs the data aggregation unit 112 to reaggregate the first aggregated data 132 if the data determination unit 115 determines that there is the first aggregated data 132.

On the other hand, if the data determination unit 115 determines that there is no first aggregated data 132 (NO in S4), the data aggregation unit 112 does not execute the process of S4.

The result output unit 116 then calculates the aggregation result corresponding to the instruction for aggregation received in the process of S1 based on the first aggregated data 132 reaggregated in the process of S5 and the aggregated data 132 other than the first aggregated data 132 in the aggregated data 132 specified in the process of S2 and outputs the aggregation result (S6). A specific example of the process from S3 to S6 will be described below.

FIGS. 5 to 7 are diagrams describing a specific example of the aggregated data 132. In the following description, the aggregated data 132 is created from each piece of the non-aggregated data 131 generated in each time zone of one hour. In the description, the aggregation in the process of S1 is instructed at given time every day.

First, a specific example of the aggregated data 132 created from the non-aggregated data 131 generated on October 29 will be described. FIG. 5 is a diagram describing a specific example of the aggregated data 132 created from the non-aggregated data 131 generated on October 29 (hereinafter, also referred to as aggregated data 132 of October 29).

As illustrated in FIG. 5, the aggregated data 132 of October 29 includes 24 pieces of aggregated data 132 from the aggregated data 132 created from the non-aggregated data 131 generated at one to two o'clock on October 29 to the aggregated data 132 created from the non-aggregated data 131 generated at 24 to 25 o'clock on October 29.

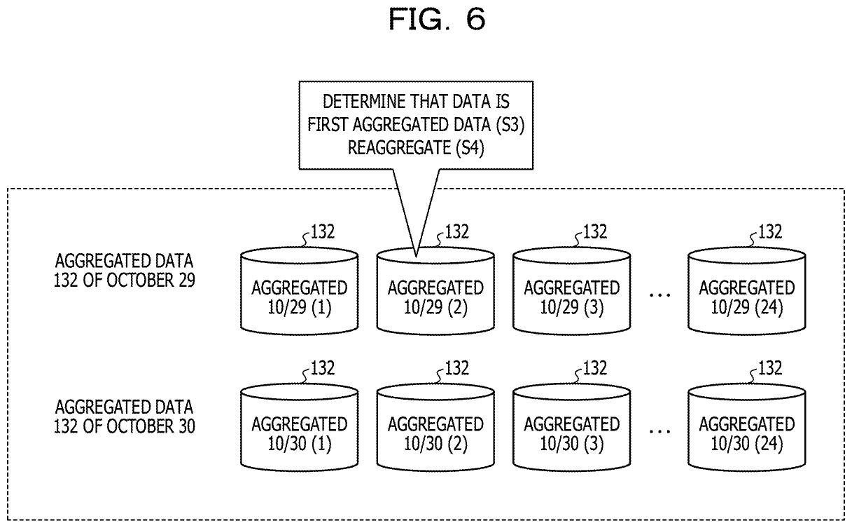

Next, a specific example of the aggregated data 132 created from the non-aggregated data 131 generated on October 30 will be described. FIG. 6 is a diagram describing a specific example of the aggregated data 132 created from the non-aggregated data 131 generated on October 30 (hereinafter, also referred to as aggregated data 132 of October 30).

As illustrated in FIG. 6, the aggregated data 132 of October 30 includes 24 pieces of aggregated data 132 from the aggregated data 132 created from the aggregated data 131 generated at one to two o'clock on October 30 to the aggregated data 132 created from the non-aggregated data 131 generated at 24 to 25 o'clock on October 30.

If, for example, an instruction for aggregation based on the aggregated data 132 of October 29 and the aggregated data 132 of October 30 is received after the creation of each piece of the aggregated data 132 of October 30 (YES in S1), the data determination unit 115 determines whether the non-aggregated data 131 generated on October 30 includes correction data for the non-aggregated data 131 generated on October 29 (S3).

For example, when the data aggregation unit 112 of the information processing apparatus 1 detects that the non-aggregated data 131 generated on October 30 includes the correction data for the non-aggregated data 131 generated on October 29 in creating the aggregated data 132 from the non-aggregated data 131 generated on October 30, the data aggregation unit 112 executes a process of adding the detected correction data to the non-aggregated data 131 generated on October 29 without notifying the data determination unit 115 and the like of the detection.

Therefore, when the data determination unit 115 receives an instruction for aggregation based on the aggregated data 132 of October 29 and the aggregated data 132 of October 30, the data determination unit 115 determines, for example, whether a hash value calculated for each piece of the non-aggregated data 131 varies between before and after the creation of the aggregated data 132 of October 30, for each piece of the non-aggregated data 131 generated at each hour on October 29.

This allows the data determination unit 115 to determine whether the data aggregation unit 112 has added the correction data to the non-aggregated data 131 generated on October 29.

As a result, if, for example, the data determination unit 115 determines that the hash value calculated from the non-aggregated data 131 generated at two to three o'clock on October 29 is changed (YES in S4), the data aggregation unit 112 determines that the correction data is added to the aggregated data 132 generated at two to three o'clock on October 29 and reaggregates the aggregated data 132 of two to three o'clock on October 29 as illustrated in FIG. 6 (S5).

In this case, the result output unit 116 calculates the aggregation result from the aggregated data 132 of October 29 (including the reaggregated aggregated data 132 of two to three o'clock) and the aggregated data 132 of October 30 and outputs the aggregation result (S6).

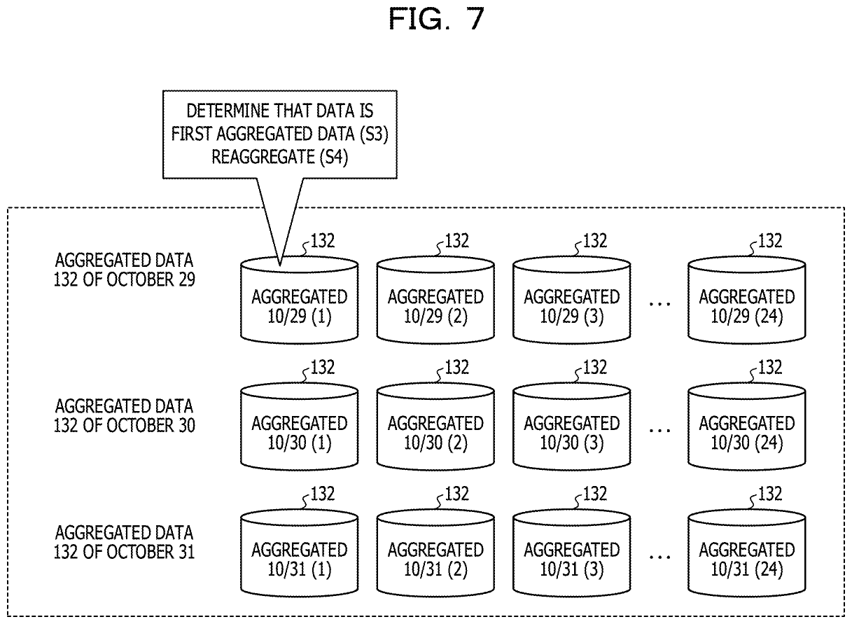

Next, a specific example of the aggregated data 132 created from the non-aggregated data 131 generated on October 31 will be described. FIG. 7 is a diagram describing a specific example of the aggregated data 132 created from the non-aggregated data 131 generated on October 31 (hereinafter, also referred to as aggregated data 132 of October 31).

As illustrated in FIG. 7, the aggregated data 132 of October 31 includes 24 pieces of aggregated data 132 from the aggregated data 132 created from the non-aggregated data 131 generated at one to two o'clock on October 31 to the aggregated data 132 created from the non-aggregated data 131 generated at 24 to 25 o'clock on October 31.

If, for example, an instruction for aggregation based on the aggregated data 132 from October 29 to October 31 is received after the creation of each piece of the aggregated data 132 of October 31 (YES in S1), the data determination unit 115 determines whether the non-aggregated data 131 generated on October 31 includes correction data for the non-aggregated data 131 generated on October 29 and October 30 (S3).

For example, when the data aggregation unit 112 detects that the non-aggregated data 131 generated on October 31 includes the correction data for the aggregated data 132 generated on October 29 or October 30 in creating the aggregated data 132 from the non-aggregated data 131 generated on October 31, the data aggregation unit 112 executes a process of adding the detected correction data to the non-aggregated data 131 generated on October 29 or October 30 without notifying the data determination unit 115 and the like of the detection.

Therefore, when the data determination unit 115 receives the instruction for aggregation based on the aggregated data 132 from October 29 to October 31, the data determination unit 115 determines, for example, whether the hash value calculated from each piece of the non-aggregated data 131 varies between before and after the creation of the aggregated data 132 of October 31, for each piece of the non-aggregated data 131 generated at each hour on October 29 and October 30.

This allows the data determination unit 115 to determine whether the data aggregation unit 112 has added the correction data to the non-aggregated data 131 generated on October 29 and October 30.

As a result, if, for example, the data determination unit 115 determines that the hash value calculated from the non-aggregated data 131 generated at one to two o'clock on October 29 is changed (YES in S4), the data aggregation unit 112 determines that the correction data is added to the aggregated data 132 generated at one to two o'clock on October 29 and reaggregates the aggregated data 132 of one to two o'clock on October 29 as illustrated in FIG. 7 (S5).

In this case, the result output unit 116 calculates the aggregation result from the aggregated data 132 of October 29 (including the reaggregated aggregated data 132 of one to two o'clock), the aggregated data 132 of October 30, and the aggregated data 132 of October 31 and outputs the aggregation result (S6).

For example, the information processing apparatus 1 specifies that the aggregated data 132 created from the non-aggregated data 131 that varies between the timing of the reception of the instruction for aggregation and the timing before the timing is the aggregated data 132 that needs to be reaggregated due to the generation of the correction data. The information processing apparatus 1 reaggregates only the specified aggregated data 132.

This allows the information processing apparatus 1 to efficiently create the aggregated data 132. Therefore, the information processing apparatus 1 may be able to shorten the time for creating the aggregated data 132 and may be able to reduce the influence of the creation of the aggregated data 132 on other processes.

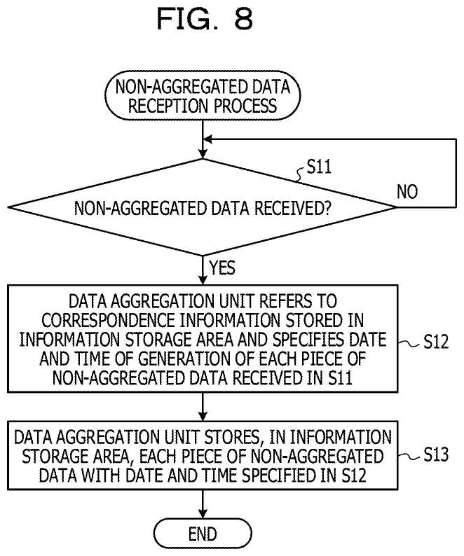

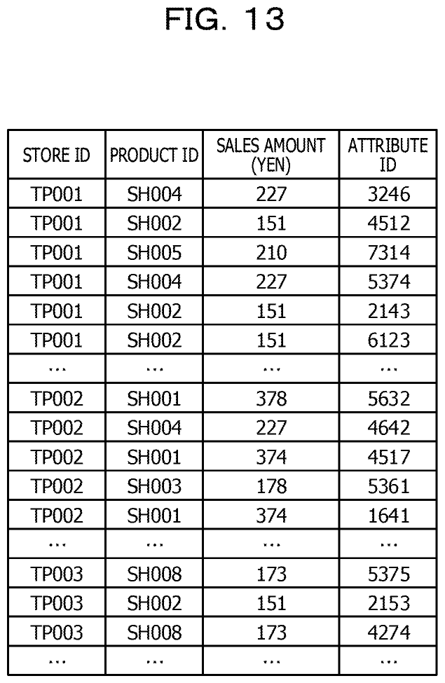

Next, details of the first embodiment will be described. FIGS. 8 to 12 are flow charts describing details of the result output process according to the first embodiment. FIGS. 13 to 18 are diagrams describing details of the result output process according to the first embodiment.

First, a process executed in response to the reception of the non-aggregated data 131 in the result output process (hereinafter, also referred to as non-aggregated data reception process) will be described. FIG. 8 is a flow chart describing the non-aggregated data reception process.

The data reception unit 111 waits for, for example, the reception of the non-aggregated data 131 transmitted from each operation terminal 3 as illustrated in FIG. 8 (NO in S11). In the following description, each operation terminal 3 transmits the non-aggregated data 131 every hour.

Note that each operation terminal 3 may irregularly transmit the non-aggregated data 131. For example, each operation terminal 3 may transmit the non-aggregated data 131 to the information processing apparatus 1 in response to the creation of the non-aggregated data 131 including a given amount of data. A specific example of the non-aggregated data 131 will be described below.

FIG. 13 is a diagram describing a specific example of non-aggregated data. For example, FIG. 13 is a diagram describing a specific example of the non-aggregated data 131 generated on October 29.

The non-aggregated data 131 illustrated in FIG. 13 is provided with “store ID” for identifying each store, “product ID” for identifying each product, “sales amount” for setting the sales amount of the sales, and “attribute ID” for identifying the attribute of the sales.

For example, in the data of the first line of the non-aggregated data 131 illustrated in FIG. 13, “TP001” is set for the “store ID,” “SH004” is set for the “product ID,” “227 (yen)” is set for the “sales amount,” and “3246” is set for the “attribute ID.” For example, the data of the first line of the non-aggregated data 131 illustrated in FIG. 13 indicates that a product with the “product ID” of “SH004” is sold in a store with the “store ID” of “TP001,” and the sales of “227 (yen)” are recorded.

In the data of the second line of the non-aggregated data 131 illustrated in FIG. 13, “TP001” is set for the “store ID,” “SH002” is set for the “product ID,” “151 (yen)” is set for the “sales amount,” and “4512” is set for the “attribute ID.” For example, the data of the second line of the non-aggregated data 131 illustrated in FIG. 13 indicates that a product with the “product ID” of “SH002” is sold in a store with the “store ID” of “TP001,” and the sales of “151 (yen)” are recorded. The other data included in FIG. 13 will not be described.

With reference again to FIG. 8, when the non-aggregated data 131 transmitted from each operation terminal 3 is received (YES in S11), the data aggregation unit 112 refers to the correspondence information (not illustrated) stored in the information storage area 130 and specifies the date and time of the generation of each piece of the non-aggregated data 131 received in the process of S11 (S12).

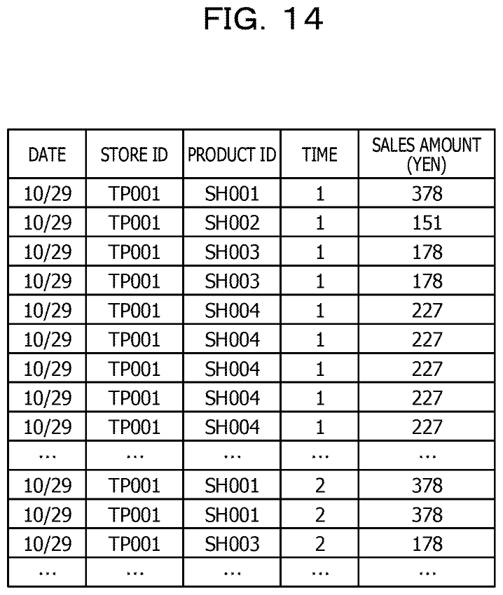

For example, the data aggregation unit 112 refers to the correspondence information (not illustrated) to convert the information set for the “attribute ID” included in each piece of the non-aggregated data 131 received in the process of S11 into information indicating the date and time of the generation of each piece of the non-aggregated data 131 (information set in “date” and “time”) as illustrated in FIG. 14.

The data aggregation unit 112 then stores, in the information storage area 130, each piece of the non-aggregated data 131 with the date and time specified in the process of S12 (S13).

For example, the non-aggregated data 131 does not include an item directly indicating the date and time of the generation of each piece of the non-aggregated data 131 as described in FIG. 13. Therefore, the data specification unit 114, the data determination unit 115, and the like may not be able to specify the date and time of the generation of each piece of the non-aggregated data 131 before the data aggregation unit 112 coverts the information set for the “attribute ID.”

Therefore, the data aggregation unit 112 specifies the date and time of the generation of each piece of the non-aggregated data 131 when the data reception unit 111 receives the non-aggregated data 131. The data aggregation unit 112 then sorts the non-aggregated data 131 according to the date and time of generation and stores the non-aggregated data 131 in the information storage area 130.

This allows the information processing apparatus 1 to specify the aggregated data 132 that needs to be reaggregated due to addition of correction data as described later.

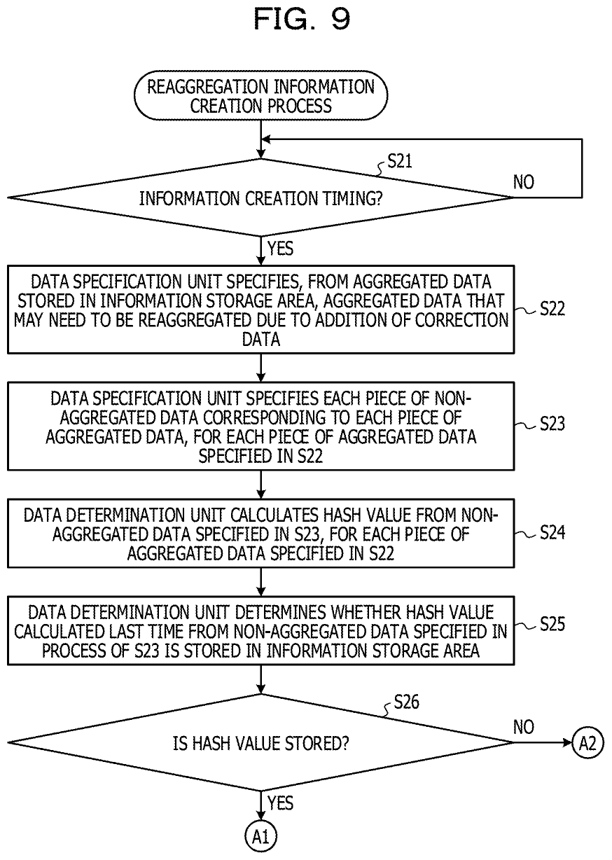

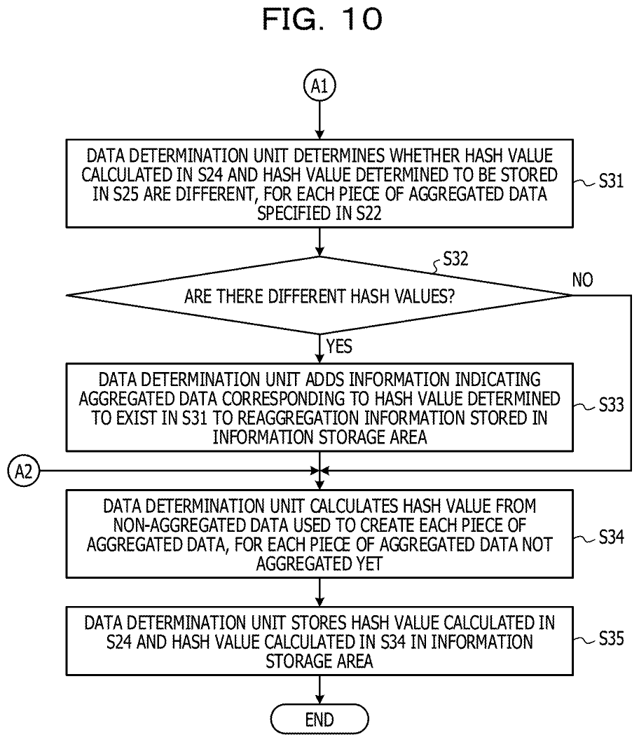

Next, a process of generating the reaggregation information 134 (hereinafter, also referred to as reaggregation information creation process) in the result output process will be described. FIGS. 9 and 10 illustrate a flow chart describing the reaggregation information creation process. Note that the reaggregation information 134 is information indicating the aggregated data 132 that needs to be reaggregated due to the generation of the correction data.

The instruction reception unit 113 of the information processing apparatus 1 waits for information creation timing as illustrated in FIG. 9 (NO in S21). The information creation timing may be, for example, timing set in advance by the provider. In the following description, the information creation timing is 2 a.m. The information creation timing may also be, for example, timing that the provider inputs an information generation instruction to the information processing apparatus 1.

When the information creation timing comes (YES in S21), the data specification unit 114 specifies, from the aggregated data 132 stored in the information storage area 130, the aggregated data 132 that may need to be reaggregated due to the addition of the correction data (S22). A specific example of the aggregated data 132 will be described later.

For example, when the non-aggregated data 131 transmitted from the operation terminal 3 may include correction data of the previous day or two days ago, the data specification unit 114 specifies the aggregated data 132 generated from the non-aggregated data 131 generated in the previous day or two days ago in the aggregated data 132 stored in the information storage area 130.

The data specification unit 114 then specifies each piece of the non-aggregated data 131 corresponding to each piece of the aggregated data 132, for each piece of the aggregated data 132 specified in the process of S22 (S23).

The data determination unit 115 calculates the hash value from the non-aggregated data 131 specified in the process of S23, for each piece of the aggregated data 132 specified in the process of S22 (S24).

The data determination unit 115 further determines whether the hash value calculated last time from the non-aggregated data 131 specified in the process of S23 is stored in the information storage area 130 (S25).

As a result, if the data determination unit 115 determines that the hash value calculated last time from the non-aggregated data 131 specified in the process of S23 is stored in the information storage area 130 (YES in S26), the data determination unit 115 determines whether the hash value calculated in the process of S24 and the hash value determined to be stored in the process of S25 are different, for each piece of the aggregated data 132 specified in the process of S22 as illustrated in FIG. 10 (S31).

For example, when the reaggregation information creation process is executed every day, the hash value calculated in the previous day from the non-aggregated data 131 specified in the process of S23 is stored in the information storage area 130 (process of S35 described later). Therefore, the data determination unit 115 may compare the hash value calculated in the process of S24 and the hash value calculated in the previous day in this case. Thus, the data determination unit 115 may determine whether the correction data is added to the non-aggregated data 131 specified in the process of S23, between the reaggregation information creation process of the previous day and the present time.

If the data determination unit 115 determines that there are different hash values (YES in S32), the data determination unit 115 adds the information indicating the aggregated data 132 corresponding to the hash value determined to exist in the process of S31 to the reaggregation information 134 stored in the information storage area 130 (S33).

For example, the data determination unit 115 determines that the aggregated data 132 stored in the information storage area 130 includes the aggregated data 132 that needs to be reaggregated due to the generation of the correction data in this case and adds the information indicating the aggregated data 132 to the reaggregation information 134.

This allows the information processing apparatus 1 to minimize the range of the aggregated data 132 that needs to be reaggregated due to the generation of the correction data.

On the other hand, if the data determination unit 115 determines that there are no different hash values (NO in S32), the data determination unit 115 does not execute the process of S33.

The data determination unit 115 then calculates the hash value from the non-aggregated data 131 used to create each piece of the aggregated data 132, for each piece of the aggregated data 132 not aggregated yet (S34).

The data determination unit 115 stores the hash value calculated in the process of S24 and the hash value calculated in the process of S34 in the information storage area 130 (S35).

For example, the data determination unit 115 stores, in the information storage area 130, the hash value to be used when the reaggregation information creation process is executed again.

Note that the data determination unit 115 similarly executes the process from S34 if the data determination unit 115 determines that the hash value calculated in the process of S24 is not stored in the information storage area 130 (NO of S26).

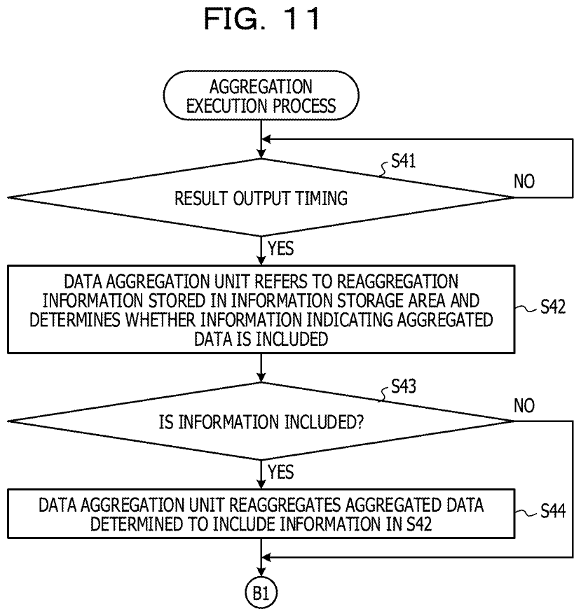

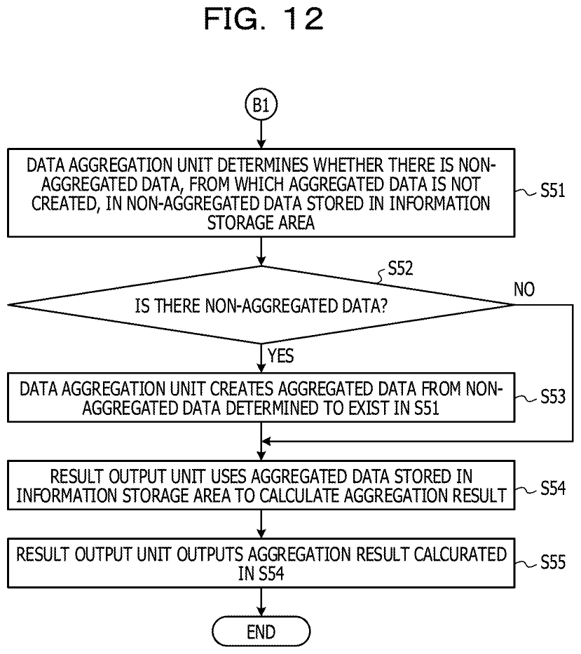

Next, a process of aggregating or reaggregating the aggregated data 132 (hereinafter, also referred to as aggregation execution process) in the result output process will be described. FIGS. 11 and 12 illustrate a flow chart describing the aggregation execution process.

The instruction reception unit 113 waits for result output timing as illustrated in FIG. 11 (NO in S41). The result output timing may be, for example, timing set in advance by the provider. In the following description, the result output timing is 9 a.m. The result output timing may also be, for example, timing that the provider inputs a result output instruction to the information processing apparatus 1.

If the result output timing comes (YES in S41), the data aggregation unit 112 refers to the reaggregation information 134 stored in the information storage area 130 and determines whether information indicating the aggregated data 132 is included (S42).

As a result, if the data aggregation unit 112 determines that the information indicating the aggregated data 132 is included (YES in S43), the data aggregation unit 112 reaggregates the aggregated data 132 determined to include the information in the process of S42 (S44).

For example, the data aggregation unit 112 reaggregates the aggregated data 132 that needs to be reaggregated according to the generation of the correction data at timing different from the execution timing of the reaggregation information creation process. This allows the information processing apparatus 1 to reduce the concentration of the processing load in the time zone of the execution of the reaggregation information creation process.

On the other hand, if the data aggregation unit 112 determines that the information indicating the aggregated data 132 is not included (NO in S43), the data aggregation unit 112 does not execute the process of S44.

The data aggregation unit 112 then determines whether there is non-aggregated data 131, from which the aggregated data 132 is not created (non-aggregated data 131 not aggregated yet), in the non-aggregated data 131 stored in the information storage area 130 as illustrated in FIG. 12 (S51).

As a result, if the data aggregation unit 112 determines that there is the non-aggregated data 131 from which the aggregated data 132 is not created (YES in S52), the data aggregation unit 112 creates the aggregated data 132 from the non-aggregated data 131 determined to exist in the process of S51 (S53).

On the other hand, if the data aggregation unit 112 determines that there is no non-aggregated data 131 from which the aggregated data 132 is not created (NO in S52), the data aggregation unit 112 does execute the process of S53.

The result output unit 116 then uses, for example, the aggregated data 132 stored in the information storage area 130 to calculate the aggregation result (S54).

For example, the result output unit 116 uses the aggregated data 132 reaggregated in the process of S44 and the aggregated data 132 aggregated in the process of S53, and also other aggregated data 132 stored in the information storage area 130 to perform the aggregation based on the aggregation method designated in advance by the provider.

Note that when, for example, the aggregation method designated in advance by the provider is “summary from the aggregated data 132 of September 1 to the aggregated data 132 of October 31,” the result output unit 116 may create summary data in advance regarding the aggregated data 132 without a possibility of reaggregation (from the aggregated data 132 of September 1 to the aggregated data 132 of October 29). In the process of S54, the result output unit 116 may use the summary data from the aggregated data 132 of September 1 to the aggregated data 132 of October 29, the aggregated data 132 of October 30, and the aggregated data 132 of October 31 to calculate the aggregation result.

This allows the result output unit 116 to shorten the time for calculating the aggregation result.

The result output unit 116 outputs, for example, the aggregation result calculated in the process of S54 to the provider terminal (not illustrated) (S55).

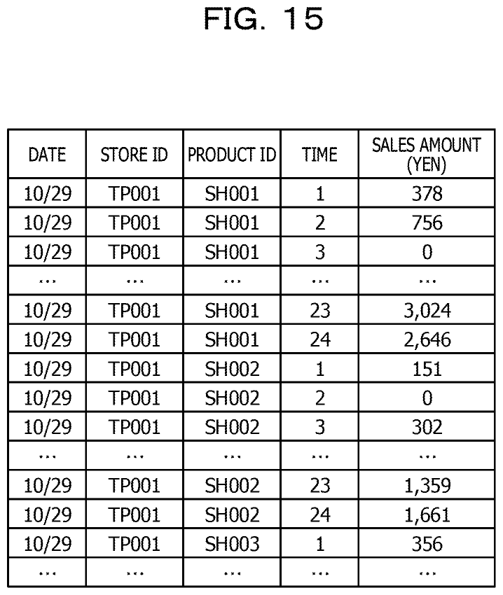

Next, a specific example of the result output process will be described. FIGS. 15 to 18 are diagrams describing a specific example of the result output process.

First, a specific example of the aggregated data 132 will be described. FIG. 15 is a diagram describing a specific example of the aggregated data 132 generated from the non-aggregated data 131 described in FIG. 14.

For example, FIG. 15 is a diagram describing a specific example of the aggregated data 132 (aggregated data 132 of October 29) created from the non-aggregated data 131 generated on October 29 (non-aggregated data 131 generated between one to two o'clock and 24 to 25 o'clock on October 29) in the aggregation execution process executed at 9 a.m. on October 30. The aggregated data 132 illustrated in FIG. 15 is aggregated data 132 aggregated for each store, each product, and each time period.

The aggregated data 132 illustrated in FIG. 15 includes items including “date” for setting the date of the generation of the non-aggregated data 131 used for aggregating each piece of the aggregated data 132, “store ID” for identifying the store that has sold the product, and “product ID” for identifying the type of the product sold. The aggregated data 132 illustrated in FIG. 15 also includes items including “time” for setting the time (time zone) of the generation of the non-aggregated data 131 used for aggregating each piece of the aggregated data 132 and “sales amount (yen)” for setting the total sales amount.

For example, in the data of the first line of the aggregated data 132 illustrated in FIG. 15, “10/29” is set for the “date,” “TP001” is set for the “store ID,” “SH001” is set for the “product ID,” “1 (one to two o'clock)” is set for the “time,” and “378 (yen)” is set for the “sales amount.”

In the data of the second line of the aggregated data 132 illustrated in FIG. 15, “10/29” is set for the “date,” “TP001” is set for the “store ID,” “SH001” is set for the “product ID,” “2 (two to three o'clock)” is set for the “time,” and “756 (yen)” is set for the “sales amount.” The other data included in FIG. 15 will not be described.

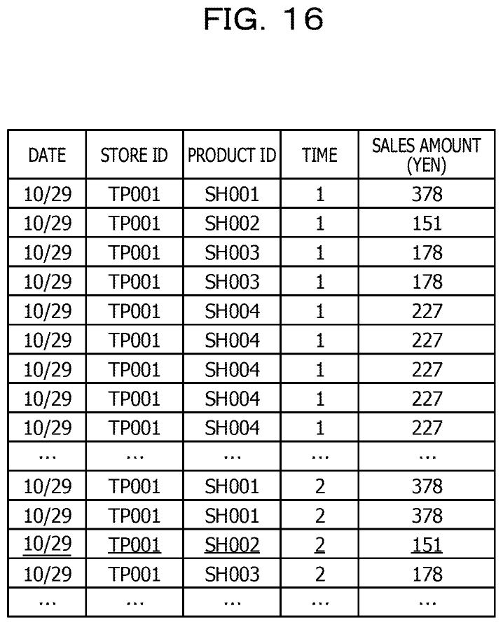

For example, when data aggregation unit 112 detects that the non-aggregated data 131 (non-aggregated data 131 transmitted from operation terminal 3) generated at two to three o'clock on October 30 during the execution of the non-aggregated data reception process includes correction data for the non-aggregated data 131 generated at two to three o'clock on October 29, the data aggregation unit 112 adds the detected correction data to the non-aggregated data 131 described in FIG. 14 as illustrated in underlined part of FIG. 16 (S13).

The data determination unit 115 then determines that the hash value created from the non-aggregated data 131 generated at two to three o'clock on October 29 is changed in the reaggregation information creation process executed at 2 a.m. on October 31 (YES in S32). Therefore, the data determination unit 115 adds the information indicating the aggregated data 132 of two to three o'clock on October 29 to the reaggregation information 134 stored in the information storage area 130 in this case.

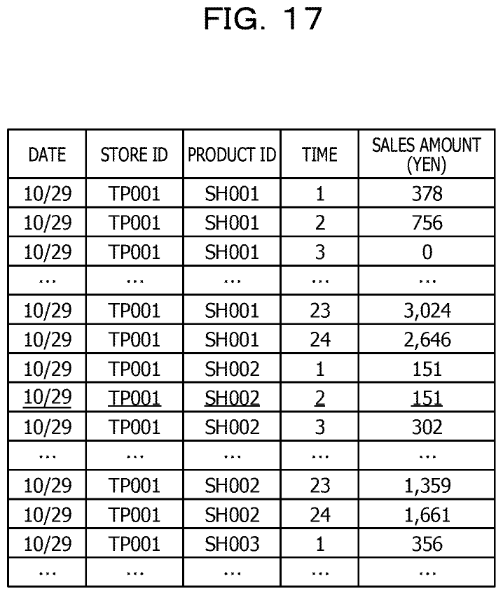

The data aggregation unit 112 then determines that the information indicating the aggregated data 132 of two to three o'clock on October 29 is included in the reaggregation information 134 in the aggregation execution process executed at 9 a.m. on October 31 and reaggregates the aggregated data 132 from the non-aggregated data 131 generated at two to three o'clock on October 29 (non-aggregated data 131 with the “store ID” of “TP001” and the “product ID” of “SH002”) as illustrated in underlined part of FIG. 17.

In this case, the data aggregation unit 112 creates the aggregated data 132 for the non-aggregated data 131 received from the operation terminal 3 (non-aggregated data 131 in which the aggregated data 132 is not aggregated yet) after the execution of the last (9 a.m. on October 30) aggregation execution process.

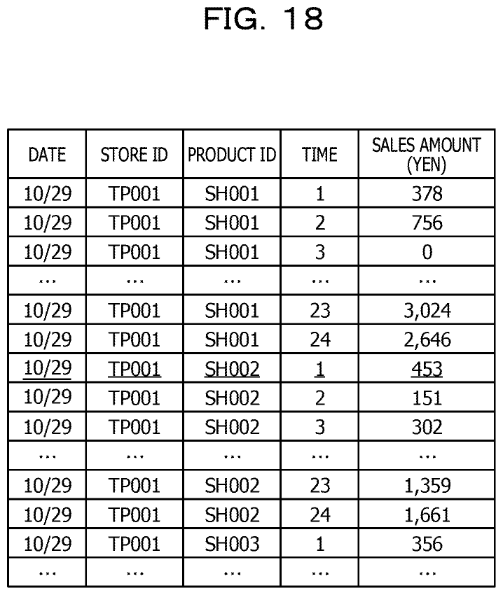

When, for example, the non-aggregated data 131 (non-aggregated data 131 transmitted from operation terminal 3) generated at one to two o'clock on October 31 includes the correction data for the non-aggregated data 131 generated at two to three o'clock on October 29 during the execution of the non-aggregated data reception process, the data aggregation unit 112 determines that the information indicating the aggregated data 132 of two to three o'clock on October 29 is included in the reaggregation information 134 in the aggregation execution process executed at 9 a.m. on November 1 and reaggregates the aggregated data 132 from the non-aggregated data 131 generated at one to two o'clock on October 29 (non-aggregated data 131 with the “store ID” of “TP001” and the “product ID” of “SH002”) as illustrated in underlined part of FIG. 18.

In this way, the information processing apparatus 1 according to the present embodiment specifies the instructed aggregated data 132 to be aggregated from the created aggregated data 132 when the information processing apparatus 1 receives an instruction for aggregating the non-aggregated data 131. The information processing apparatus 1 then determines whether the specified aggregated data 132 includes the first aggregated data 132 created from the non-aggregated data 131 in which the data at certain timing before the reception of the instruction for aggregation and the data at the timing of the reception of the instruction for aggregation are different.

As a result, the information processing apparatus 1 reaggregates the first aggregated data 132 when the information processing apparatus 1 determines that there is the first aggregated data 132. The information processing apparatus 1 then calculates the aggregation result corresponding to the instruction for aggregation based on the reaggregated first aggregated data 132 and the aggregated data 132 other than the first aggregated data 132 in the specified aggregated data 132 and outputs the aggregation result.

For example, the information processing apparatus 1 specifies that the aggregated data 132 corresponding to the data that varies between the timing of the reception of the instruction for aggregation and the timing before the timing is the aggregated data 132 that needs to be reaggregated due to the generation of the correction data. The information processing apparatus 1 reaggregates only the specified aggregated data 132.

This allows the information processing apparatus 1 to shorten the time for creating the aggregated data 132. Therefore, the information processing apparatus 1 may be able to reduce the influence of the aggregation of the aggregated data 132 on other processes.

Note that when, for example, the aggregation execution process is executed every several days while the reaggregation information creation process is executed every day, the information processing apparatus 1 executes the aggregation execution process corresponding to each day from the day of the execution of the aggregation execution process of the last time to the present day.

For example, when the aggregation execution process is executed every day until October 30, and the date of the next aggregation execution process is November 1 (when the aggregation execution process is not executed on October 31), the information processing apparatus 1 first executes the aggregation execution process (aggregation execution process for October 31) by setting the non-aggregated data 131 generated on October 29 and October 30 as the non-aggregated data 131 with a possibility of addition of correction data. The information processing apparatus 1 then executes the aggregation execution process (aggregation execution process for November 1) by setting the non-aggregated data 131 generated on October 30 and October 31 as the non-aggregated data 131 with a possibility of addition of correction data.

This allows the information processing apparatus 1 to execute the result output process while maintaining the consistency of data even when the aggregation execution process is not executed every day.

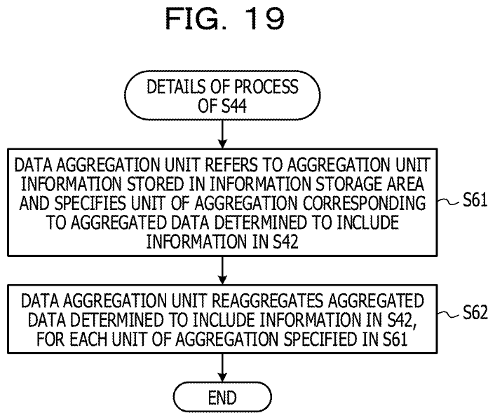

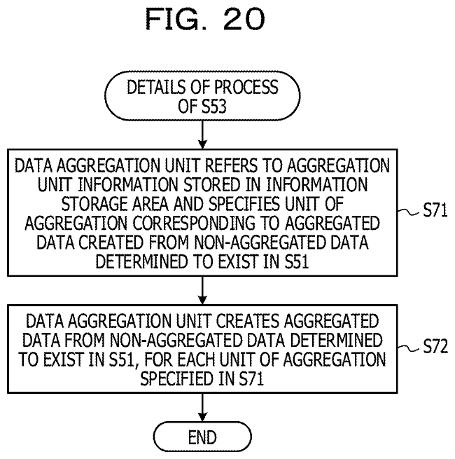

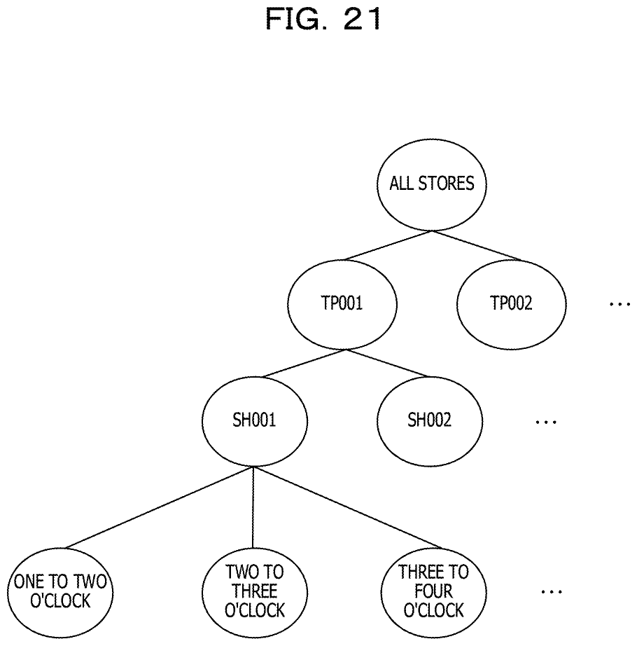

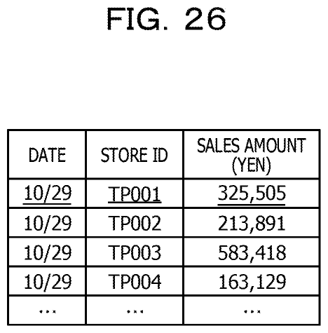

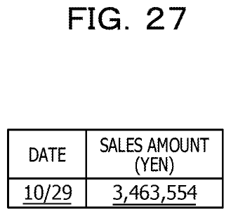

Next, a second embodiment will be described. FIGS. 19 and 20 illustrate a flow chart describing a result output process according to the second embodiment. FIGS. 21 to 27 are diagrams describing the result output process according to the second embodiment.

In the result output process according to the second embodiment, the aggregated data 132 is created from the same non-aggregated data 131 based on a plurality of units of aggregation, unlike in the case described in the first embodiment.

In the result output process according to the second embodiment, only the details of the processes of S44 and S53 are different from the result output process according to the first embodiment. Therefore, only the details of the processes of S44 and S53 in the result output process according to the second embodiment will be described.

First, the details of the process of S44 according to the second embodiment will be described. FIG. 19 is a flow chart describing the details of the process of S44 according to the second embodiment.

The data aggregation unit 112 refers to the aggregation unit information 133 stored in the information storage area 130 and specifies the unit of aggregation corresponding to the aggregated data 132 determined to include the information in the process of S42 as illustrated in FIG. 19 (S61). A specific example of the aggregation unit information 133 will be described below.

FIG. 21 is a diagram describing a specific example of the aggregation unit information 133. The aggregation unit information 133 is, for example, information with a tree structure as illustrated in FIG. 21.

For example, in the aggregation unit information 133 illustrated in FIG. 21, “all stores” are positioned in a first tier (top tier), and “TP001,” “TP002,” and the like indicating the “store ID” of each store are positioned in a second tier (second tier from the top). In the aggregation unit information 133 illustrated in FIG. 21, “SH001,” “SH002,” and the like indicating the “product ID” of each product sold in each store are positioned in a third tier (third tier from the top), and “one to two o'clock,” “two to three o'clock,” and the like indicating each time period that each product is sold are positioned in a fourth tier (bottom tier).

For example, the aggregation unit information 133 illustrated in FIG. 21 indicates that when the aggregated data 132 of each store, each product, and each time period (aggregated data 132 corresponding to fourth tier) is reaggregated, the reaggregated data 132 of each store and each product (aggregated data 132 corresponding to third tier) needs to be reaggregated. In addition, the aggregated data 132 of each store (aggregated data 132 corresponding to second tier) needs to be reaggregated, and the aggregated data 132 of all stores (aggregated data corresponding to first tier) needs to be reaggregated.

For example, the aggregated data 132 described in FIG. 15 is the aggregated data 132 for each store, each product, and each time period. Therefore, the data aggregation unit 112 specifies the unit of aggregation for each store, each product, and each time period as well as the unit of aggregation for each store and each product, the unit of aggregation for each store, and the unit of aggregation for all stores in the process of S61.

Other than the example described in FIG. 21, the aggregation unit information 133 may include, for example, information indicating that the aggregated data 132 for each product needs to be reaggregated. The aggregated data 132 of each unit of aggregation will be described below.

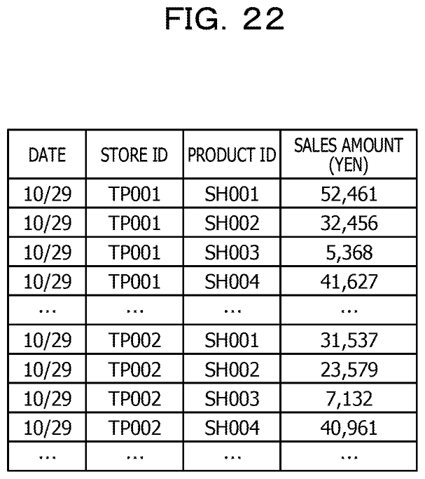

First, a specific example of the aggregated data 132 for each store and each product will be described. FIG. 22 is a diagram describing a specific example of the aggregated data 132 for each store and each product. The aggregated data 132 illustrated in FIG. 22 is created from the non-aggregated data 131 described in FIG. 14, just like the aggregated data 132 described in FIG. 15.

The aggregated data 132 illustrated in FIG. 22 includes items including “date” for setting the date of the generation of the non-aggregated data 131 used for aggregating each piece of the aggregated data 132, “store ID” for identifying the store that has sold the product, and “product ID” for identifying the type of the product sold. The aggregated data 132 illustrated in FIG. 22 also includes an item “sales amount (yen)” for setting the total sales amount.

For example, in the data of the first line of the aggregated data 132 illustrated in FIG. 22, “10/29” is set for the “date,” “TP001” is set for the “store ID,” “SH001” is set for the “product ID,” and “52,461 (yen)” is set for the “sales amount.”

In the data of the second line of the aggregated data 132 illustrated in FIG. 22, “10/29” is set for the “date,” “TP001” is set for the “store ID,” “SH002” is set for the “product ID,” and “32,456 (yen)” is set for the “sales amount.” Other data included in FIG. 22 will not be described.

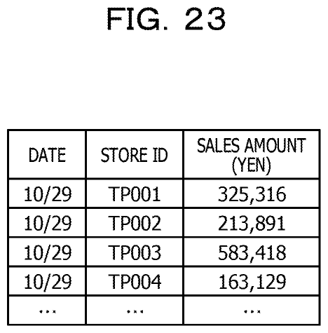

Next, a specific example of the aggregated data 132 for each store will be described. FIG. 23 is a diagram describing a specific example of the aggregated data 132 for each store. The aggregated data 132 illustrated in FIG. 23 is created from the non-aggregated data 131 described in FIG. 14, just like the aggregated data 132 described in FIG. 15.

The aggregated data 132 illustrated in FIG. 23 includes items including “date” for setting the date of the generation of the non-aggregated data 131 used for aggregating each piece of the aggregated data 132, “store ID” for identifying the store that has sold the product, and “sales amount (yen)” for setting the total sales amount.

For example, in the data of the first line of the aggregated data 132 illustrated in FIG. 23, “10/29” is set for the “date,” “TP001” is set for the “store ID,” and “325,316 (yen)” is set for the “sales amount.”

In the data of the second line of the aggregated data 132 illustrated in FIG. 23, “10/29” is set for the “date,” “TP002” is set for the “store ID,” and “213,891 (yen)” is set for the “sales amount.” Other data included in FIG. 23 will not be described.

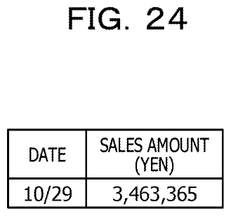

Next, a specific example of the aggregated data 132 for all stores will be described. FIG. 24 is a diagram describing a specific example of the aggregated data 132 for all stores. The aggregated data 132 illustrated in FIG. 24 is created from the non-aggregated data 131 described in FIG. 14, just like the aggregated data 132 described in FIG. 15.

The aggregated data 132 illustrated in FIG. 24 includes items including “date” for setting the date of the generation of the non-aggregated data 131 used for aggregating each piece of the aggregated data 132 and “sales amount (yen)” for setting the total sales amount.

For example, in the data of the first line of the aggregated data 132 illustrated in FIG. 24, “10/29” is set for the “date,” and “3,463,365 (yen)” is set for the “sales amount.”

With reference again to FIG. 19, the data aggregation unit 112 reaggregates the aggregated data determined to include the information in S42, for each unit of aggregation specified in the process of S61 (S62).

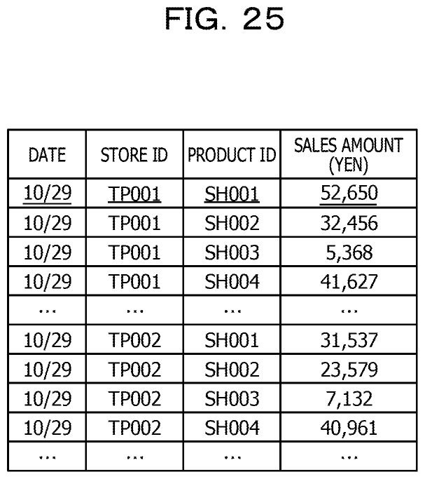

For example, the data aggregation unit 112 reaggregates the aggregated data 132 for each unit of aggregation specified in the process of S61 as illustrated in underlined parts of FIGS. 25 to 27.

This allows the information processing apparatus 1 to comprehensively reaggregate the aggregated data 132 that needs to be reaggregated due to the generation of the correction data even when there are a plurality of units of aggregation for the aggregated data 132.

Next, details of the process of S53 according to the second embodiment will be described. FIG. 20 is a flow chart describing details of the process of S53 according to the second embodiment.

The data aggregation unit 112 refers to the aggregation unit information 133 stored in the information storage area 130 and specifies the unit of aggregation corresponding to the aggregated data 132 generated from the non-aggregated data 131 determined to exist in the process of S51 (S71).

The data aggregation unit 112 creates the aggregated data 132 from the non-aggregated data 131 determined to exist in the process of S51, for each unit of aggregation specified in the process of S71 (S72).

This allows the information processing apparatus 1 to comprehensively create the desirable aggregated data 132 even when the aggregated data 132 is to be created in a plurality of units of aggregation.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An aggregation apparatus comprising:
one or more memories; and
one or more processors coupled to the one or more memories and the one or more processors configured to
identify, in response to receiving an instruction for aggregation, one or more aggregation results related to the instruction from a plurality of aggregation results of a plurality of periods stored in the one or more memories,
perform determination of whether the identified one or more aggregation results include a first aggregation result aggregated by using first data at first timing before second timing of the receiving of the instruction, the first data being different from second data at the second timing,
perform calculation of a second aggregation result by using the first data when it is determined that the identified one or more aggregation results include the first aggregation result, and
perform output for the instruction based on the calculated second aggregation result and one or more aggregation results other than the first aggregation result in the identified one or more aggregation results.

2. The aggregation apparatus according to claim 1, wherein
the determination includes determining whether a first hash value calculated by the first data is different from a second hash value calculated by the second data.

3. The aggregation apparatus according to claim 1, wherein
the plurality of periods include a plurality of periods having different lengths.

4. The aggregation apparatus according to claim 1, wherein
the one or more processors are configured to, when a third aggregation result related to the instruction is not aggregated, calculate the third aggregation result before the calculation of the second aggregation result.

5. The aggregation apparatus according to claim 1, wherein
the determination is a process of performing the determination only for aggregation results with a possibility of being the first aggregation results from among the identified one or more aggregated results.

6. The aggregation apparatus according to claim 1, wherein
the plurality of aggregation results include a plurality of aggregation results in a plurality of units of aggregation, and
the first aggregation result includes a first plurality of aggregation results in the plurality of units of aggregation.

7. The aggregation apparatus according to claim 6, wherein
the plurality of units of aggregation include at least one of a unit of stores that sell products and a unit of types of products.

8. A computer-implemented aggregation method comprising:
identifying, in response to receiving an instruction for aggregation, one or more aggregation results related to the instruction from a plurality of aggregation results of a plurality of periods stored in the one or more memories;
determining whether the identified one or more aggregation results include a first aggregation result aggregated by using first data at first timing before second timing of the receiving of the instruction, the first data being different from second data at the second timing;
calculating a second aggregation result by using the first data when it is determined that the identified one or more aggregation results include the first aggregation result; and
performing output for the instruction based on the calculated second aggregation result and one or more aggregation results other than the first aggregation result in the identified one or more aggregation results.

9. The aggregation method according to claim 8, wherein
the determining includes determining whether a first hash value calculated by the first data is different from a second hash value calculated by the second data.

10. The aggregation method according to claim 8, wherein
the plurality of periods include a plurality of periods having different lengths.

11. The aggregation method according to claim 8, further comprising:
when a third aggregation result related to the instruction is not aggregated, calculating the third aggregation result before the calculation of the second aggregation result.

12. The aggregation method according to claim 8, wherein
the determining is a process of performing the determining only for aggregation results with a possibility of being the first aggregation results from among the identified one or more aggregated results.

13. The aggregation method according to claim 9, wherein
the plurality of aggregation results include a plurality of aggregation results in a plurality of units of aggregation, and
the first aggregation result includes a first plurality of aggregation results in the plurality of units of aggregation.

14. The aggregation method according to claim 13, wherein
the plurality of units of aggregation include at least one of a unit of stores that sell products and a unit of types of products.

15. A non-transitory computer-readable medium storing instructions executable by one or more computers, the instructions comprising:
one or more instructions for identifying, in response to receiving an instruction for aggregation, one or more aggregation results related to the instruction from a plurality of aggregation results of a plurality of periods stored in the one or more memories;
one or more instructions for determining whether the identified one or more aggregation results include a first aggregation result aggregated by using first data at first timing before second timing of the receiving of the instruction, the first data being different from second data at the second timing;
one or more instructions for calculating a second aggregation result by using the first data when it is determined that the identified one or more aggregation results include the first aggregation result; and
one or more instructions for performing output for the instruction based on the calculated second aggregation result and one or more aggregation results other than the first aggregation result in the identified one or more aggregation results.
